(19) United States
(12) Patent Application Publication
(10) Pub. No.: US 2017/0337284 A1
(43) Pub. Date: Nov. 23, 2017

(54) DETERMINING AND USING ATTRIBUTES OF MESSAGE EXCHANGE THREAD PARTICIPANTS

(71) Applicant: Google Inc., Mountain View, CA (US)

(72) Inventors: Maryam Garrett, Cambridge, MA (US); Wan Fen Nicole Quah, Cambridge, MA (US); Bryan Horling, Belmont, MA (US); Ruijie He, Roxbury Crossing, MA (US)

(21) Appl. No.: 15/157,382

(22) Filed: May 17, 2016

(51) Int. Cl. G06F 17/30; G10L 13/08; G06F 3/0488; H04L 12/58

(52) U.S. Cl. CPC G06F 17/30867; H04L 51/16; G10L 13/08; G06F 17/30554; G06F 3/0488; G06F 17/30528; G06F 17/30401; G06F 17/3053

(57) ABSTRACT

Methods, apparatus, systems, and computer-readable media are provided for: determining, based on a participant-contributed message of a first message exchange thread accessible to a personal assistant module that is associated with a participant of the thread, one or more attributes of at least a first participant of the first message exchange thread; storing, by the personal assistant module, the one or more attributes in association with the first participant; forming, by the personal assistant module, a search query based on content of the first message exchange thread or content of a second message exchange thread involving the participant; obtaining, by the personal assistant module, content responsive to the search query; and incorporating, by the personal assistant module, into the first or second thread, message(s) associated with the responsive content. The search query includes one or more items selected based on the stored attribute(s) of the first participant.

### BACKGROUND

Personal assistant modules are software processes installed on computing devices such as smart phones, tablets, vehicle navigation systems, and smart watches to provide user-friendly interfaces for users to issue natural language commands. Users often issue natural language commands using their voices, but personal assistant modules may respond to other modalities as well, such as various forms of textual and/or image input. Users may communicate with personal assistant modules and/or each other via message exchange threads implemented using various technologies, such as text messaging, online chat (e.g., instant messenger, Internet relay chat, etc.), social network threads, interactive voice response, and so forth. The ongoing message exchange thread may be limited to text, audio, or other data such as pictures that are incorporated into the message exchange thread by the participants or the personal assistant module.

### SUMMARY

The present disclosure is generally directed to methods, apparatus, and computer-readable media (transitory and non-transitory) for determining attributes of message exchange thread participants and using those attributes later. Suppose a user engages in multiple conversational flows with his or her personal assistant module. These conversations may or may not include other users (or “participants”) as well. In one or more conversations, the user and the personal assistant module exchange several messages in an effort to, for instance, pick a suitable restaurant. Along the way, the user and/or other participants may implicitly or explicitly express preferences and choices that may be applicable to similar conversations in the future. For example, a participant might indicate a cuisine preference (“I'm vegetarian”), cost preference (“Nothing too fancy”), time preference (“I'm free at 8”), and so forth.

In various implementations, these interactions may be stored on behalf of the participant associated with the personal assistant module. In some implementations those interactions may be interpreted and/or annotated, and in some instances associated with the time and/or location of one or more of the participants when the conversation took place. This information can later be used to improve subsequent conversational flows. For example, if the participant who previously expressed an interest in French cuisine says “I'm hungry,” the personal assistant module may reply, “Ok, are you up for French food again?”, and present an appropriately constrained set of options in lieu of a broader set of alternatives that might otherwise be shown. This can be accomplished, for instance by searching the history associated with the participant associated with the personal assistant module for relevant statements. For example, a search may be performed of all instances where a cuisine preference has been mentioned. The results may then narrowed based on various signals, such as a location at which the preference was mentioned, a time at which it was mentioned, etc. If, for instance, the participant searches dinner options, then dinner messages/preferences may be used in favor of breakfast. Messages may similarly be narrowed to those previously stated at or near their current location. For example, the participant's preferences might be different at home versus when traveling.

In some implementations, a personal assistant module may determine, from content of a message exchange thread, attributes of the participant with which they are associated and/or another participant based on content of the message exchange thread. These determined attributes and/or the messages that conveyed the attributes may be stored for subsequent use by the personal assistant module when augmenting a message exchange thread. When the personal assistant module is later instructed (or otherwise stimulated) to formulate and/or submit a search query to one or more components of a knowledge system, the search query may be formed with both content from the message exchange thread (e.g., “Where should we eat?”) and with one or more items selected based on the stored participant attributes (e.g., participant A earlier indicated being short on funds, so form query to find mid-priced (“$$”) or low-priced (“$”) restaurants only).

Additionally or alternatively, the stored participant attributes may be used to bias responsive content, rather than forming a search query. For example, one or more components of the aforementioned knowledge system may bias results based on the stored participant attributes before it returns the responsive content to a client device. Or, in some implementations, the personal assistant module may bias the responsive content it receives from the knowledge system based on the stored participant attributes.

As an example, suppose a first participant of a message exchange thread tells a second participant (or a plurality of other participants), “I don't like Chinese food.” A personal assistant module with access to (e.g., participating in) the message exchange thread may infer from this statement that at least one participant of the thread (the personal assistant module may or may not have the ability to discern between multiple participants in WR-based implementations) does not like Chinese food. The personal assistant module may store this attribute. After some intervening time period, or even in a subsequent message exchange thread with the same or similar participants, when a participant asks, “BOT, what's a good and cheap lunch spot nearby?”, the personal assistant module may formulate a search query that excludes Chinese restaurants. Additionally or alternatively the personal assistant module may submit a search query formed exclusively from the participant's request in the thread, and then bias the results to discard or at least assign low ranks to results pertaining to Chinese restaurants.

In some implementations, a method may be provided that includes the following operations: determining, by a personal assistant module operated by one or more processors, based on a participant-contributed message of a first message exchange thread that is accessible to the personal assistant module, one or more attributes of at least a first participant of the first message exchange thread. The personal assistant module is associated with a participant of the first message exchange thread and the method further includes: storing, by the personal assistant module, the one or more attributes in association with the first participant; forming, by the personal assistant module, a search query based at least in part on content of the first message exchange thread or content of a second message exchange thread involving the participant associated with the personal assistant module. The search query further includes one or more items selected based on the stored one or more attributes of the first participant and the method further includes: obtaining, by the personal assistant module, content responsive to the search query; and incorporating, by the personal assistant module, into the first or second message exchange thread, one or more messages associated with the responsive content.

This method and other implementations of technology disclosed herein may each optionally include one or more of the following features.

In some implementations, the participant associated with the personal assistant module is the first participant.

In some implementations, the personal assistant module is associated with a second participant in the first message exchange thread that is different than the first participant.

In some implementations, the incorporating includes audibly rendering, via one or more speakers, the one or more messages associated with the responsive content as computer-generated speech.

In some implementations, the incorporating includes visually rendering one or more graphical elements associated with the responsive content on a display.

In some implementations, the incorporating includes requesting that at least one message exchange client operated by at least one participant of the first or second message exchange thread insert one or more graphical elements into a transcript of the first or second message exchange thread. The transcript is displayed in a graphical user interface of the at least one message exchange client, and the one or more graphical elements is associated with the responsive content. In some of those implementations, the one or more graphical elements comprise: text that conveys the responsive content and/or one or more images that convey the responsive content.

In some implementations, the participant-contributed message is directed from one participant of the first message exchange thread to another participant. In some of those implementations, the determining includes inferring the one or more attributes based on the participant-contributed message.

In some implementations, the one or more attributes include a preference of the first user.

In some implementations, the forming includes forming the search query to capture search results related to the one or more attributes.

In some implementations, the forming comprises forming the search query to exclude search results related to the one or more attributes.

In some implementations, a method may be provided that includes the following operations: determining, based on a participant-contributed message of a first message exchange thread that is accessible to the personal assistant module, one or more attributes of at least a first participant of the first message exchange thread. The personal assistant module is associated with a second participant of the first message exchange thread and the method further includes: storing the one or more attributes in association with the first participant; forming a search query from content of the first message exchange thread or content of a second exchange thread involving the second participant; obtaining a plurality of items responsive to the search query. The plurality of items are assigned rankings based at least in part on the one or more attributes and the method further includes: selectively incorporating, into the first or second message exchange thread, one or more messages associated with the plurality of items based at least in part on the rankings.

This method and other implementations of technology disclosed herein may each optionally include one or more of the following features.

In some implementations, the selectively incorporating includes audible rendition, via one or more speakers, of the one or more messages associated with the responsive content as computer-generated speech.

In some implementations, the selectively incorporating includes visual rendition of one or more graphical elements associated with the responsive content on a display.

In some implementations, the selectively incorporating includes requesting that at least one message exchange client operated by at least one participant of the first or second message exchange thread insert one or more graphical elements into a transcript of the first or second message exchange thread. The transcript is displayed in a graphical user interface of at least one message exchange client, and the one or more graphical elements is associated with the plurality of items. In some of those implementations, the one or more graphical elements include text that conveys the one or more messages and/or one or more images that convey the one or more messages.

In some implementations, a method may be provided that includes the following operations: determining, based on a participant-contributed message of a first message exchange thread between at least first and second participants, one or more attributes of the first participant; storing the one or more attributes in association with the first participant; forming a search query based at least in part on content of the first message exchange thread or content of a second message exchange thread involving the second participant, wherein the search query further includes one or more items selected based on the stored one or more attributes of the first participant; obtaining content responsive to the search query; and providing data associated with the responsive content to the second participant.

Other implementations may include a non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an environment in which one or more graphical elements may be incorporated into a message exchange thread, in accordance with various implementations.

FIG. 2, FIG. 3, FIG. 4, and FIG. 5 each depict examples of determining attributes of message exchange thread participants and using those attributes later, in accordance with various implementations.

FIG. 6 depicts a flow chart illustrating an example method of determining attributes of message exchange thread participants and using those attributes later, in accordance with various implementations.

FIG. 7 schematically depicts an example architecture of a computer system.

### DETAILED DESCRIPTION

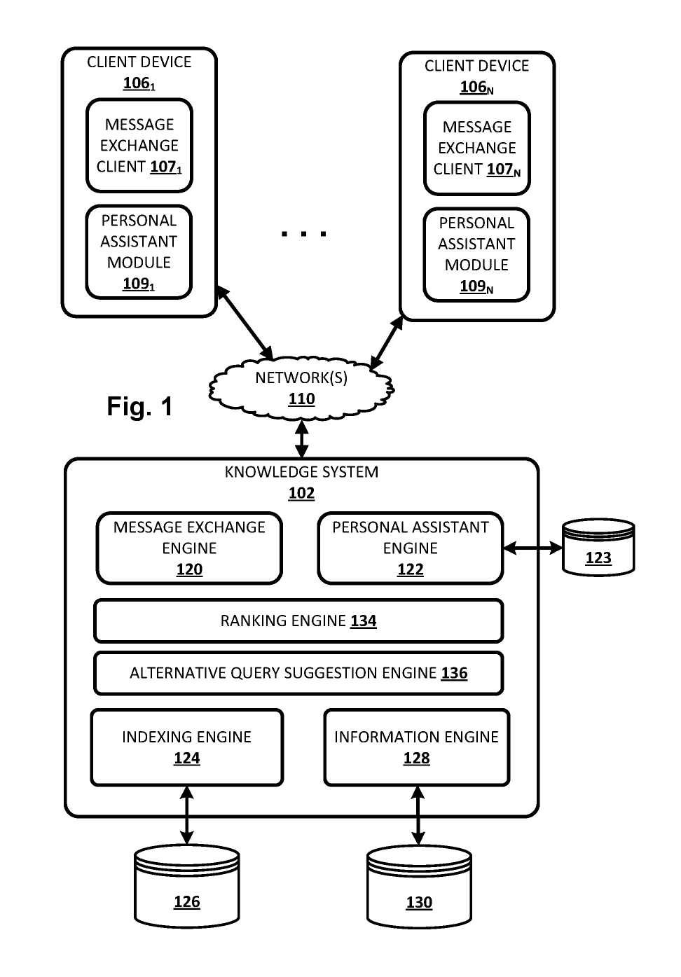

FIG. 1 illustrates an environment suitable for determining attributes of message exchange thread participants and using those attributes later. The example environment includes a plurality of client devices 106_{1-N} and a knowledge system 102. Knowledge system 102 may be implemented in one or more computers that communicate, for example, through a network. Knowledge system 102 is an example of an information retrieval system in which the systems, components, and techniques described herein may be implemented and/or with which systems, components, and techniques described herein may interface.

A user may interact with knowledge system 102 via a client device 106. Each client device 106 may be a computer coupled to the knowledge system 102 through one or more networks 110 such as a local area network (LAN) or wide area network (WAN) such as the Internet. Each client device 106 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone voice command device, or a wearable apparatus of the participant that includes a computing device (e.g., a watch of the participant having a computing device, glasses of the participant having a computing device). Additional and/or alternative client devices may be provided. The participant likely will operate a plurality of computing devices that collectively form a coordinated “ecosystem” of computing devices that may or may not be owned by the participant, and that may or may not be associated with an online account of the participant. However, for the sake of brevity, examples described in this disclosure will focus on the participant operating a single client device 106.

Each client device 106 may operate a variety of different applications, such as a message exchange client 107 and/or a personal assistant module 109. Message exchange client 107 may come in various forms. In some implementations, message exchange client 107 may come in the form of a short messaging service (“SMS”) and/or multimedia messaging service (“MMS”) client, an online chat client (e.g., instant messenger, Internet relay chat, or “IRC,” etc.), a messaging application associated with a social network, an interface used to communicate with a personal assistant module 109, and so forth. In some implementations, message exchange client 107 may be implemented within a webpage rendered by a web browser (not depicted). In various instances, two client devices 106 operated by participants of a message exchange thread may run different message exchange clients 107 that nonetheless facilitate communication using a common communication protocol. For example, client device 106₁ may have one SMS application distributed by one vendor installed, and client device 106N may have another SMS application distributed by another vendor installed.

As described in the background, personal assistant module 109 may take the form of a software process installed on a given client computing device 106 to provide user-friendly interfaces for users to issue natural language commands. Personal assistant module 109 may be invoked or “awakened” by various stimuli, such as a user speaking one or more code words that are selected to activate personal assistant module 109. In various implementations described herein, a user may communicate with a personal assistant module 109 in a message exchange thread, e.g., using voice input, text input, and so forth. Further, personal assistant module 109 may participate in a message exchange thread that involves multiple message exchange clients 107 operating on multiple client devices 106 and controlled by multiple participants. For example, and as will be described in more detail below, personal assistant module 109 may automatically select and incorporate content into a message exchange thread in response to one or more messages contributed to the message exchange thread by one or more participants.

Each of client device 106 and knowledge system 102 may include one or more memories for storage of data and software applications, one or more processors for accessing data and executing applications, and other components that facilitate communication over a network. The operations performed by client device 106 and/or knowledge system 102 may be distributed across multiple computer systems. Knowledge system 102 may be implemented as, for example, computer programs running on one or more computers in one or more locations that are coupled to each other through a network.

In various implementations, knowledge system 102 may include a message exchange engine 120, one or more personal assistant engines 122, an indexing engine 124, an information engine 128, a ranking engine 134, and an alternative query suggestion engine 136. In some implementations one or more of engines 120, 122, 124, 128, 134, and/or 136 may be omitted. In some implementations all or aspects of one or more of engines 120, 122, 124, 128, 134, and/or 136 may be combined. In some implementations, one or more of engines 120, 122, 124, 128, 134, and/or 136 may be implemented in a component that is separate from knowledge system 102. In some implementations, one or more of engines 120, 122, 124, 128, 134, and/or 136, or any operative portion thereof, may be implemented in a component that is executed by client device 106.

In various implementations, message exchange engine 120 may be configured to facilitate a message exchange thread between multiple message exchange clients 107 operating on multiple client devices 106 controlled by multiple participants. In some implementations, message exchange engine 120 may maintain a global “transcript” of messages and other content participants exchange with each other in a message exchange thread. As used herein, a “transcript” may refer to a live record of text, images, sounds, and/or applets exchanged and/or viewed by one or more participants in a message exchange thread. In some implementations, a transcript of a message exchange thread may be updated in real time or near real time as the participants converse. In scenarios in which a single participant communicates with personal assistant module 109, the transcript may be maintained locally by personal assistant module 109 and/or remotely by personal assistant engine 122.

In various implementations, personal assistant engine 122 may include complementary functionality for handling voice input, e.g., using a voice-based query processor that relies on various online acoustic/language, grammar and/or action models that may be stored in index 123. It will be appreciated that in some implementations, particularly as most client devices 106 are resource-constrained devices, personal assistant engine 122 may implement more complex and computational resource-intensive voice processing functionality than is local to each client device 106. It should be further understood that when an action is described herein as being performed by personal assistant module 109, that may or may not also include one or more aspects of the action being performed by personal assistant engine 122.

In some implementations, multiple personal assistant engines 122 may be employed, each acting as an online counterpart for one or more individual personal assistant modules 109. For example, in some implementations, each client device 106 in a user's ecosystem may be configured to operate an instance of a personal assistant module 109 that is associated with the user (e.g., configured with the user's preferences, associated with the same interaction history, etc.). A single, user-centric online instance of personal assistant engine 122 may be accessible to each of these multiple instances of personal assistant module 109, depending on which device the user is operating at the time.

In some implementations, both online and offline functionality may be supported, e.g., such that online functionality is used whenever a client device 106 is in communication with an online service, while offline functionality is used when no connectivity exists. In other implementations different actions or action domains may be allocated to online and offline functionality, and while in still other implementations, online functionality may be used only when offline functionality fails to adequately handle a particular voice input. In other implementations, however, no complementary online functionality may be used.

In various implementations, personal assistant module 109 and/or personal assistant engine 122 may store, for later use, messages exchanged between participants and/or attributes learned about participants from those messages. For example, personal assistant module 109 may store one or more attributes of one or more participants in message exchange threads it has access to (e.g., is involved in) in memory local to the respective client device 106. Personal assistant engine 122 may store one or more attributes of one or more participants in message exchange threads it has access to (e.g., is involved in, via message exchange engine 120, etc.) in index 123. Additionally or alternatively, personal assistant module 109 and/or personal assistant engine 122 may store messages themselves, e.g., in index 123. In some implementations, these messages may be annotated, e.g., with a timestamp, location where the message was contributed to a message exchange thread, subject matter of the message, etc. These stored messages and annotations (or metadata as the case may be) may be used later to improve conversational flow between a participant and his/her personal assistant module 109, and/or to improve conversation between multiple participants (including the participant associated with the personal assistant module 109).

Indexing engine 124 may maintain an index 126 for use by knowledge system 102. The indexing engine 124 processes documents and updates index entries in the index 126, for example, using conventional and/or other indexing techniques. For example, the indexing engine 124 may crawl one or more resources such as the World Wide Web and index documents accessed via such crawling. As another example, the indexing engine 124 may receive information related to one or documents from one or more resources such as web masters controlling such documents and index the documents based on such information. A document is any data that is associated with a document address. Documents include web pages, word processing documents, portable document format (PDF) documents, images, emails, calendar entries, videos, and web feeds, to name just a few. Each document may include content such as, for example: text, images, videos, sounds, embedded information (e.g., meta information and/or hyperlinks); and/or embedded instructions (e.g., ECMAScript implementations such as JavaScript).

Information engine 128 may maintain another index 130 that includes or facilitates access to non-document-specific information for use by the knowledge system 102. For example, knowledge system 102 may be configured to return information in response to search queries that appear to seek specific information. If a participant searches for “Ronald Reagan's birthday,” knowledge system 102 may receive, e.g., from information engine 128, the date, “Feb. 6, 1911.” This information may be returned to the participant as a part of search results that is separate from documents received from indexing engine 124. In various implementations, index 130 itself may contain information, or it may link to one or more other sources of information, such as online encyclopedias, almanacs, and so forth. In various implementations, index 126 or index 130 may include mappings between queries (or query terms) and documents and/or information.

In this specification, the term “database” and “index” will be used broadly to refer to any collection of data. The data of the database and/or the index does not need to be structured in any particular way and it can be stored on storage devices in one or more geographic locations. Thus, for example, the indices 123, 126, and 130 may include multiple collections of data, each of which may be organized and accessed differently.

Ranking engine 134 may use the indices 126 and/or 130 to identify documents and other information responsive to a search query, for example, using conventional and/or other information retrieval techniques. The ranking engine 134 may calculate scores for the documents and other information identified as responsive to a search query, for example, using one or more ranking signals. Each ranking signal may provide information about the document or information itself, the relationship between the document or information and the search query, and/or the relationship between the document or information and the participant performing the search.

Alternative query suggestion engine 136 may use one or more signals and/or other information, such as a database of alternative query suggestions (not depicted) and/or information about a user of client device 106 (e.g., search history, GPS location, user attributes), to generate alternative query suggestions to provide to client device 106 along with any search results. As a user types consecutive characters of the search query, alternative query suggestion engine 136 may identify alternative queries that may be likely to yield results that are useful to the user. For instance, assume the client device 106 is located in Chicago, and has typed the characters, “restaur.” Alternative query suggestion engine 136 may, based on a location signal indicating that the client device 106 is in Chicago and a search history signal indicating a user's preference for restaurants with live music, suggest a query, “restaurants in Chicago with live music.” As another example, for a user who has typed “Ronald Reagan's birt,” alternative query suggestion engine 136 may, e.g., using techniques such as prefix matching, determine and suggest alternative queries such as “Ronald Reagan's birthday,” “Ronald Reagan's birthplace,” “Ronald Reagan's birth control position,” and so forth. Alternative query suggestion engine 136 may provide other suggestions as well, such as spelling-corrected versions of a partially-formed search query.

In various implementations, various components of client device 106 and/or knowledge system 102, such as personal assistant module 109, message exchange engine 120, and/or personal assistant engine 122, may be configured to determine, based on a participant-contributed message of a first message exchange thread, one or more attributes of at least a first participant of the first message exchange thread. In some implementations, at least one personal assistant module 109 is associated with a participant of the first message exchange thread, although this is not required. One or more of these components may then store the one or more attributes in association with the first participant, e.g., in index 123 and/or memory local to client device 106.

Later, either during the same first message exchange or during a second message exchange involving at least some of the same participants, one or more of these components may form a search query based at least in part on content of the current message exchange thread. In various implementations, the search query may further include one or more items selected based on the stored one or more attributes of the first participant.

Content responsive to the search query may then be obtained, e.g., from indexing engine 124, information engine 128, or even locally from a client device 106 (e.g., SMS/MMS history, calendar entries, photographs, videos, games, reminders and so forth). One or more messages associated with the responsive content may then be incorporated, e.g., by personal assistant module 109, message exchange engine 120, message exchange client 107, or personal assistant engine 122, into the current message exchange thread. In various implementations, content responsive to the search query may further include alternative query suggestions returned from alternative query suggestion engine 136. In some implementations, content responsive to the search query may be ranked by ranking engine 134 prior to it being provided to message exchange engine 120.

Based on the content that is responsive to the search query, various items associated with the responsive content may be incorporated in the current message exchange thread, such as graphical elements (words, images, animations, applets), sounds, etc. The incorporated items may be perceptible by one or more of the participants in the message exchange thread, e.g., on a graphical user interface associated with a message exchange client 107 that depicts a transcript of the ongoing message exchange thread, or as audible output (e.g., computer-generated speech from personal assistant module 109).

Items may be incorporated into a message exchange thread between multiple message exchange clients 107 in a variety of ways. In some implementations, message exchange engine 120, personal assistant engine 122, or personal assistant module 109 may request that at least one message exchange client 107 participating in the message exchange thread insert one or more graphical elements associated with the responsive content into a transcript of the ongoing message exchange thread that is displayed in a graphical user interface of the at least one message exchange client 107. In some scenarios, the graphical elements may be incorporated into transcripts rendered by more than one message exchange client 107, such as in transcripts rendered by all message exchange clients 107 participating in the message exchange thread. In some implementations, message exchange engine 120 may simply provide responsive content to message exchange client 107, which may then select what content to incorporate into the message exchange thread.

Various types of graphical elements may be incorporated into the message exchange thread. In some implementations, the one or more graphical elements may include text that conveys information that is responsive to the search query formulated using techniques described herein. In addition to or instead of text, in various implementations, the one or more graphical elements that are incorporated into the message exchange thread may include one or more images that convey the content responsive to the search query.

In many instances, the information responsive to the search query may be too unwieldy (e.g., too long, too much detail, etc.) to feasibly incorporate into the message exchange thread without disrupting the flow of the conversation. In such situations, a subset of the total responsive information may be selected (i.e., the total responsive information may be culled) for incorporation into the thread. The subset may include, for instance, snippets of text/images extracted from one or more responsive documents (e.g., the N highest ranked documents), and/or information provided by information engine 128.

In some implementations, message exchange engine 120 and/or personal assistant engine 122 may select the subset (or cull the responsive information) for incorporation into the message exchange thread. In other implementations, message exchange engine 120 and/or personal assistant engine 122 may provide the comprehensive responsive information to one or more components of client device 106, and those client device components may perform the culling. For example, in some implementations, message exchange client 107 and/or personal assistant module 109 may cull the information based on a screen size of the host client device 106. In some implementations, the top N search results may be selected for incorporation into the message exchange thread. N may be selected based on, for instance, screen size, participant preferences, etc., or may be manually selected (e.g., N could be set to five, ten, two, one, etc.)

Whether text or images are incorporated into the message exchange thread, in various implementations, the graphical elements may link to one or more electronic documents that are responsive to the search query, such that a participant need only select the graphical elements to be directed to a new resource (e.g., a web browser displaying the information). In some implementations, the one or more graphical elements may link to an application—installed on a client device 106 operating at least one of the message exchange clients 107—that is responsive to the search query. For example, if a participant inputs into the message exchange thread, “boy, I could sure go for dinner at Frank's.” One or more graphical elements related to the location Frank's may be incorporated into the message exchange thread, e.g., by message exchange engine 120. The one or more graphical elements may be selectable to open one application on client device 106 that is operable specifically to create a reservation at the location Frank's, and/or another application that is operable to display a map and/or directions to Frank's.

In some implementations, one or more graphical elements may be incorporated into the message exchange thread that are generated based on information received from alternative query suggestion engine 136 in response to a query extracted from content of the message exchange thread. For example, suppose a participant begins operating her message exchange client 107 to pose the question, “Who was the eighteenth president of the United States?” Before the participant has completed the question, say, after typing the following characters—“who was the eight”—her partially-typed question may be submitted to knowledge system 102. Knowledge system 102 may obtain one or more alternative query suggestions from alternative query suggestion engine 136 that are potentially completed versions of what the participant is currently typing. In response to receiving these completed versions, client device 106 may render, as part of a graphical user interface of message exchange client 107, one or more graphical elements, such as buttons, that the participant can select to complete her query. For example, the participant may see the following two buttons appear: “Who was the eighth president of the United States?”, and “Who was the eighteenth president of the United States?” After the participant selects an alternative query suggestion and the selected auto-text is displayed in the thread, in some implementations, one or more follow-up questions may be provided, e.g., by alternative query suggestion engine 136, such as “In what years did that President serve?”, or “What was that President's most notable accomplishment?” Selectable graphical elements such as buttons corresponding to these follow-up questions may be provided to the participant in case, for example, the participant is quizzing someone else on history, e.g., as part of a study session.

In some implementations, knowledge system 102 may have, e.g., as part of information engine 128 and/or another component, a so-called knowledge base that contains records of known entities (e.g., people, places, things) and relationships between the known entities. In some implementations, such a knowledge base may be implemented, e.g., in index 130, as a graph in which nodes represent entities and edges represent relationships between entities, although this is not required. In some such implementations, information about entities from such a knowledge base may be made available to various components of knowledge system 102, e.g., in response to a search query formed using techniques described herein.

In some implementations, the knowledge base may be used, e.g., by message exchange engine 120 and/or information engine 128, to identify a first entity mentioned in the one or more messages exchanged between the two or more participants as part of the message exchange thread. Information responsive to a search query related to the entity may then be incorporated into the message exchange thread. Suppose a user mentions a particular movie. Once that move is identified in the knowledge base, various information about the movie, such as its critical score, main cast, director, etc., may be contributed to the message exchange thread, e.g., by personal assistant module 109 and/or personal assistant engine 122.

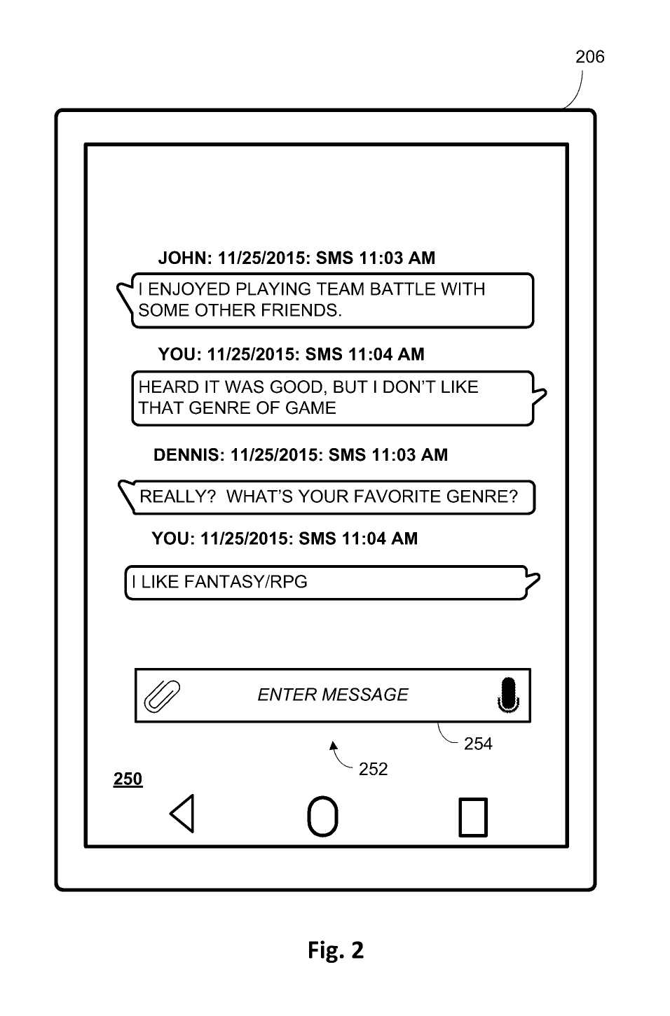

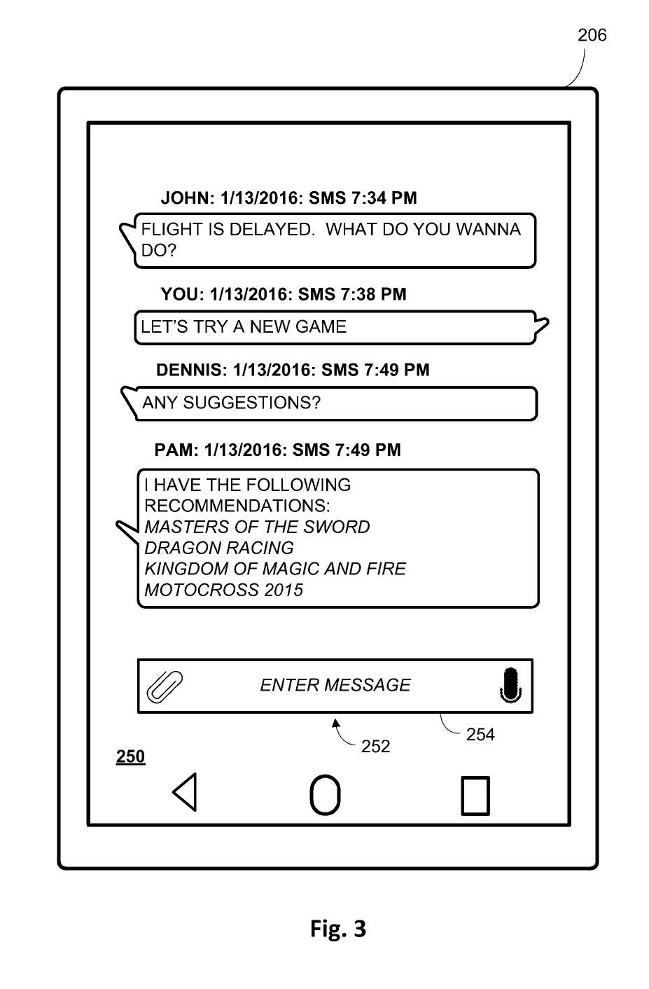

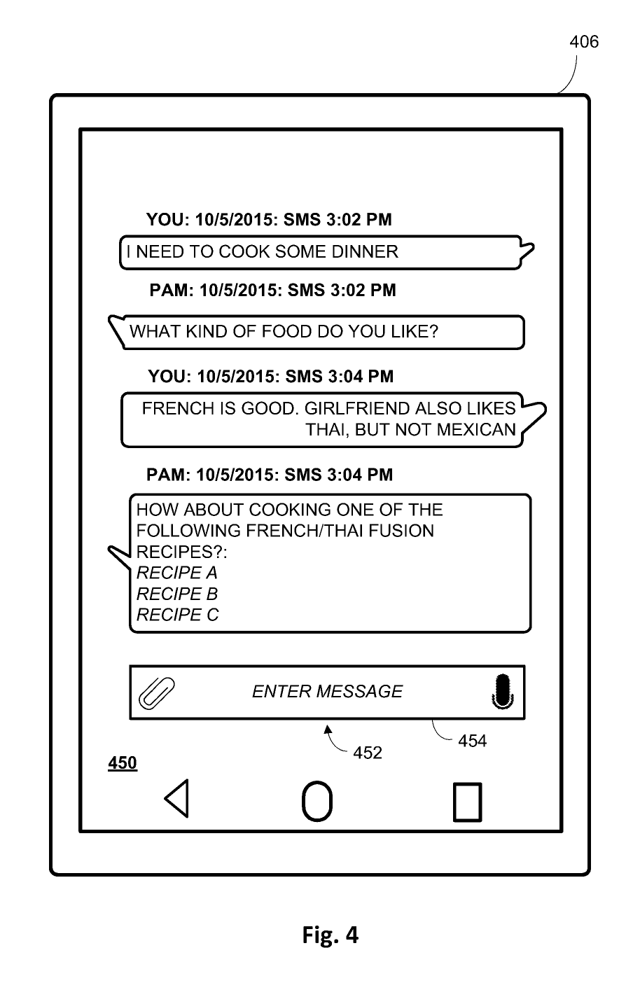

FIG. 2 depicts an example client device 206 operated by a participant named Sven (referred to as “you”). Client device 206 includes a graphical user interface 250 associated with a message exchange client (not depicted specifically in FIG. 2) that operates on client device 206. Graphical user interface 250 displays a transcript 252 of a message exchange thread between Sven and two other participants, John and Dennis. Graphical user interface 250 also includes a text input field 254 that Sven can use to input text or other content into the message exchange thread, e.g., in response to previous statements by the other two. In this example, John has stated that he enjoyed playing a game called “Team Battle” with some other people who are not participants in this message exchange thread. Sven (“You” in FIG. 2 because this is Sven's client device 206) responded that he doesn't like that genre of game (e.g., “military”). Dennis then asks, “Really? What is your favorite genre”? Sven responded with “I like Fantasy/RPG.”

In various implementations, one or more of these exchanged messages, or attributes about the participants determined from these messages, may be stored (e.g., in index 123 and/or locally on a client device) for later use. For example, Sven may be associated with attributes of “DISLIKES MILITARY GAMES,” “LIKES FANTASY GAMES” and “LIKES RPG GAMES.” John may be associated with attributes such as “HAS PLAYED TEAM BATTLE” and “LIKES MILITARY GAMES.” These attributes (or the messages themselves) may later be used, e.g., by a personal assistant module that is associated with Sven (or any of the other participants), to improve conversational flow in message exchange threads, particularly message exchange threads involving the same or similar participants.

An example of what this might look like is depicted in FIG. 3, which depicts a transcript 252 of a later message exchange thread between the same three participants. John asks what the other two users would like to do while waiting for a delayed flight. Sven says, “let's try a new game.” Dennis asks for suggestions. Sven's personal assistant module (“PAM” in FIG. 3) responds by generating a search query for submission, e.g., to an app server associated with knowledge system 102, for suggested games. Because Sven suggested trying a new game, the query may be formulated (or results may be biased) to exclude any games any of the participants has already played, such as “TEAM BATTLE” (which John had previously indicated having played). The search query also may be formulated to exclude “MILITARY GAMES” because Sven previously expressed a distaste for that genre of game. Further, the query may be formulated to include and/or assign relatively higher rankings to “FANTASY” and “RPG” games because Sven said he liked those genres earlier. Consequently, the personal assistant module suggests multiple FANTASY/RPG games, followed by a racing game (which no one expressed a distaste for). In various embodiments, content responsive to a search results may also be ranked by various signals other than the participants' attributes, such as popularity, relevance to a statement that prompted the search, etc.

FIG. 4 depicts another example client device 406 operated by a participant named Sven. In this example, Sven is participating in a message exchange thread with his personal assistant module (“PAM” in FIG. 4). Sven has indicated to his personal assistant module that he needs to prepare dinner. The personal assistant module asks about Sven's food preferences. Sven responds that he likes French food, and that his girlfriend likes Thai but not Mexican food. The personal assistant module then uses these statements to formulate a search query that seeks recipes for French/Thai fusion recipes, and returns responsive results. As noted above, these attributes and/or messages may be stored in associated with Sven and/or his girlfriend for future use. Sven's girlfriend may be inferred in various ways, such as from his social network profile and/or from explicit statements from Sven.

FIG. 5 once again depicts Sven's client device 406, except that this time he is engaging in a message exchange thread with his girlfriend, Delia. Sven asks what Delia would like to do for Valentine's Day, and Delia responds, “Let's go out to eat.” Sven asks Delia for suggestions. Sven's personal assistant module (“PAM” in FIG. 5) responds to Sven's request by search past messages (such as those depicted in FIG. 4) and/or stored attributes for Sven and Delia to formulate a search query. Because the search query seeks restaurants for Valentine's Day dinner, past messages and/or attributes that pertain to dinner dining may be particularly helpful. The search query may exclude Mexican restaurants because Delia does not like Mexican food, and instead provide as responsive content some French/Thai fusion restaurants as suggestions.

Personal assistant modules are not limited to using techniques described herein to incorporate plain text messages into message exchange threads, as was depicted in FIGS. 3-5. In various implementations, personal assistant modules may incorporate other items into message exchange threads as well. For example, in some visual-based implementations, personal assistant modules may utilize techniques described herein incorporate selectable links (e.g., hyperlinks, icons, etc.) into message exchange threads. As noted above, these selectable links may be operable by participants to perform various functions. In some implementations, a selectable link may be presented that links to an application that is relevant to a conversation. For example, rather than simply suggesting French/Thai fusion restaurants as depicted in FIG. 5, selectable links to those restaurants' webpages may be presented. Additionally or alternatively, the selectable links may be links to applications that are pertinent to the conversation, such as restaurant reservation applications (that if clicked, prepopulate various data points such as number of diners), mapping applications (that if clicked, provide directions to the restaurants), and so forth. In the example of FIG. 3, for instance, links to application installers may be provided in addition to or instead of the suggested games. In some implementations, selectable links may include auto responses that incorporate content responsive to search queries formulated using techniques described herein. For example, if one participant asks another, “What flight did you book?”, the other participant's personal assistant module may obtain flight itinerary information, e.g., from the other participant's email. The other participant may then be presented with a button that lists her flight itinerary. Upon selecting the button, data indicative of the other participant's flight itinerary may be incorporated into the thread automatically.

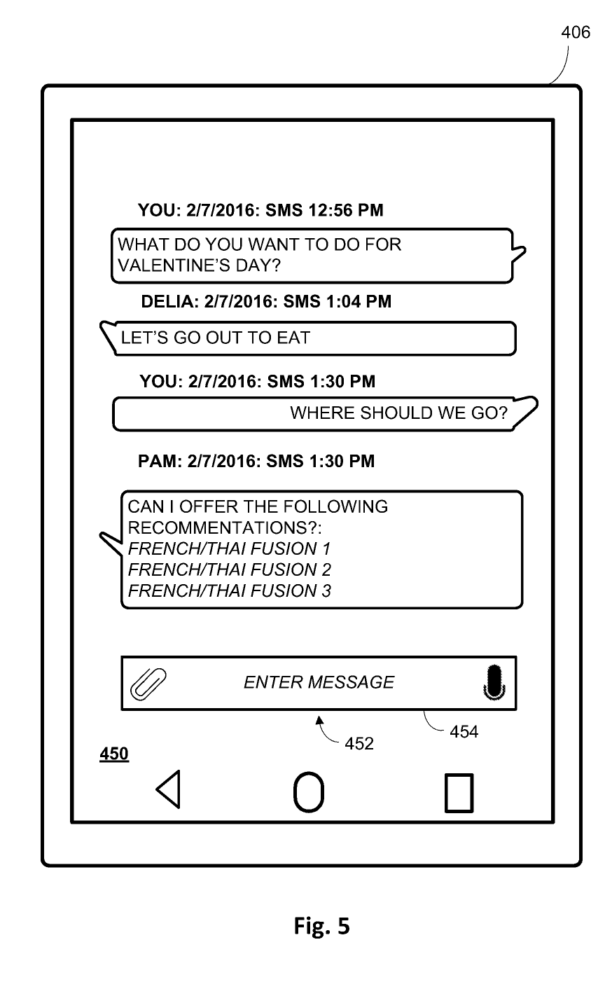

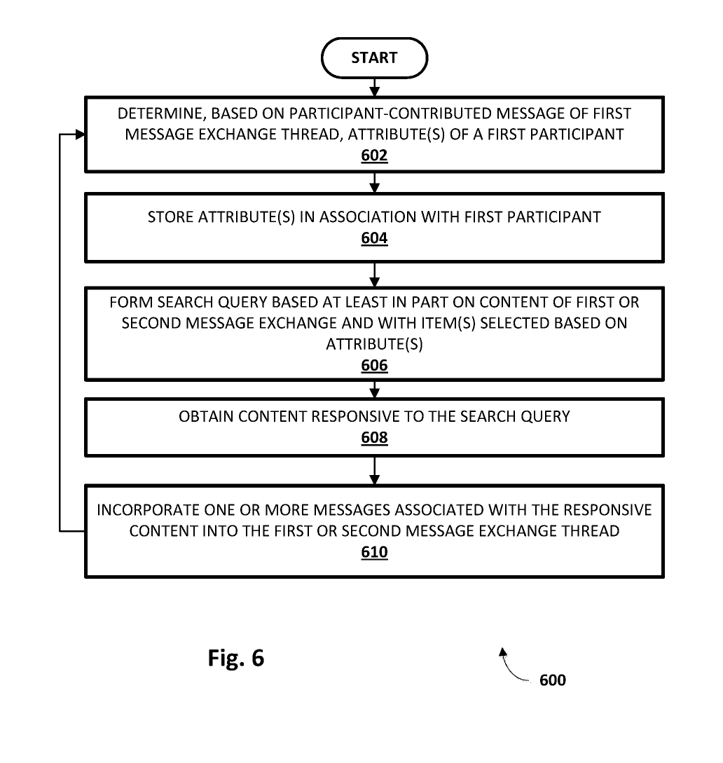

Referring now to FIG. 6, one example method 600 of determining and using attributes of message exchange thread participants is described. For convenience, the operations of the flow chart are described with reference to a system that performs the operations. This system may include various components of various computer systems, including various engines described herein. Moreover, while operations of method 600 are shown in a particular order, this is not meant to be limiting. One or more operations may be reordered, omitted or added.

At block 602, the system may determine, based on one or more participant-contributed messages of a first message exchange thread, one or attributes of a first participant. For example, one or more messages of the thread may be annotated (e.g., with timestamp, location, participant that contributed the message, etc.). Additionally or alternatively, one or more attributes may be extracted from the messages independent of the messages. At block 604, the messages and/or attributes may be, e.g., in association with the participant that contributed the message and/or a participant to which the message referred.

At block 606, during the same first message exchange thread or during a subsequent second message exchange thread (i.e., a “current” message exchange thread), one or more search queries may be formulated based at least in part on content of the current exchange thread. For example, a participant may pose a question, to another participant or to a personal assistant module that is associated with one or more participants of the thread. Or, a participant may mention an entity that is matched to an entity in a knowledge base. The one or more search queries may be formulated using one or more items selected based on the attributes stored at block 604. For example, if a participant mentioned being vegan, the search query may be formulated to include vegan restaurants and/or to exclude steak houses. In various implementations, multiple search queries may be formed for submission to multiple data sources.

At block 608, one or more search queries formed at block 606 may be submitted to various sources, such as various components of knowledge system 102 and/or to one or more client devices 106 operated by one or more participants of the message exchange thread, and responsive content may be obtained. At block 610, one or more messages associated with the responsive content may be incorporated into the current message exchange thread.

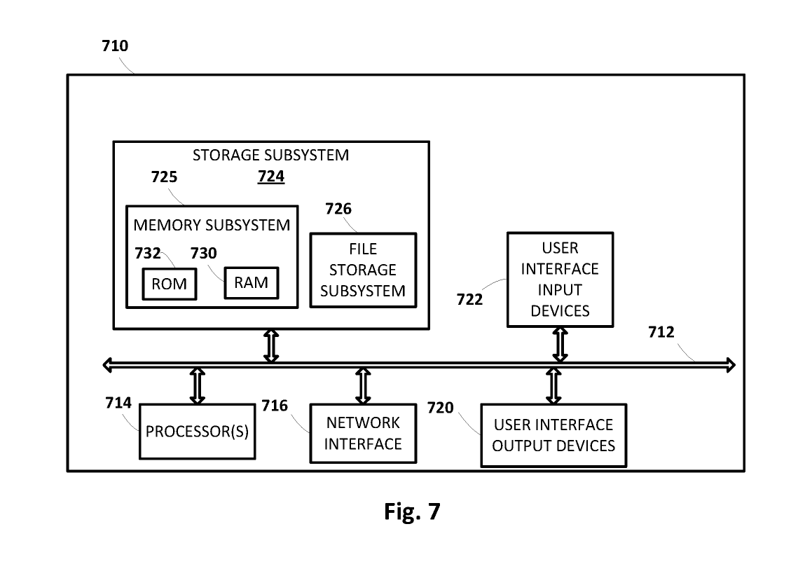

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform selected aspects of method 600, and/or to implement one or more of message exchange client 107, personal assistant module 109, message exchange engine 120, personal assistant engine 122, indexing engine 124, information engine 128, ranking engine 134, and/or alternative query suggestion engine 136.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
determining, by a personal assistant module operated by one or more processors, based on a participant-contributed message of a first message exchange thread that is accessible to the personal assistant module, one or more attributes of at least a first participant of the first message exchange thread, wherein the personal assistant module is associated with a participant of the first message exchange thread;
storing, by the personal assistant module, the one or more attributes in association with the first participant;
forming, by the personal assistant module, a search query based at least in part on content of the first message exchange thread or content of a second message exchange thread involving the participant associated with the personal assistant module, wherein the search query further includes one or more items selected based on the stored one or more attributes of the first participant;
obtaining, by the personal assistant module, content responsive to the search query; and
incorporating, by the personal assistant module, into the first or second message exchange thread, one or more messages associated with the responsive content.

2. The computer-implemented method of claim 1, wherein the participant associated with the personal assistant module is the first participant.

3. The computer-implemented method of claim 1, wherein the personal assistant module is associated with a second participant in the first message exchange thread that is different than the first participant.

4. The computer-implemented method of claim 1, wherein the incorporating comprises audibly rendering, via one or more speakers, the one or more messages associated with the responsive content as computer-generated speech.

5. The computer-implemented method of claim 1, wherein the incorporating comprising visually rendering one or more graphical elements associated with the responsive content on a display.

6. The computer-implemented method of claim 1, wherein the incorporating comprises requesting that at least one message exchange client operated by at least one participant of the first or second message exchange thread insert one or more graphical elements into a transcript of the first or second message exchange thread, wherein the transcript is displayed in a graphical user interface of the at least one message exchange client, and wherein the one or more graphical elements is associated with the responsive content.

7. The computer-implemented method of claim 6, wherein the one or more graphical elements comprise text that conveys the responsive content.

8. The computer-implemented method of claim 6, wherein the one or more graphical elements comprise one or more images that convey the responsive content.

9. The computer-implemented method of claim 1, wherein the participant-contributed message is directed from one participant of the first message exchange thread to another participant.

10. The computer-implemented method of claim 9, wherein the determining comprises inferring the one or more attributes based on the participant-contributed message.

11. The computer-implemented method of claim 1, wherein the one or more attributes comprise a preference of the first user.

12. The computer-implemented method of claim 1, wherein the forming comprises forming the search query to capture search results related to the one or more attributes.

13. The computer-implemented method of claim 1, wherein the forming comprises forming the search query to exclude search results related to the one or more attributes.

14. A system comprising memory and one or more processors, the memory storing instructions that, when executed by the one or more processors, cause the one or more processors to operate a personal assistant module configured to:
determine, based on a participant-contributed message of a first message exchange thread that is accessible to the personal assistant module, one or more attributes of at least a first participant of the first message exchange thread, wherein the personal assistant module is associated with a second participant of the first message exchange thread;
store the one or more attributes in association with the first participant;
form a search query from content of the first message exchange thread or content of a second exchange thread involving the second participant;
obtain a plurality of items responsive to the search query, wherein the plurality of items are assigned rankings based at least in part on the one or more attributes; and
selectively incorporate, into the first or second message exchange thread, one or more messages associated with the plurality of items based at least in part on the rankings.

15. The system of claim 14, wherein the selective incorporation comprises audible rendition, via one or more speakers, of the one or more messages associated with the responsive content as computer-generated speech.

16. The system of claim 14, wherein the selective incorporation comprising visual rendition of one or more graphical elements associated with the responsive content on a display.

17. The system of claim 14, wherein the selective incorporation comprises requesting that at least one message exchange client operated by at least one participant of the first or second message exchange thread insert one or more graphical elements into a transcript of the first or second message exchange thread, wherein the transcript is displayed in a graphical user interface of at least one message exchange client, and wherein the one or more graphical elements is associated with the plurality of items.

18. The system of claim 17, wherein the one or more graphical elements comprise text that conveys the one or more messages.

19. The system of claim 17, wherein the one or more graphical elements comprise one or more images that convey the one or more messages.

20. At least one non-transitory computer-readable medium comprising instructions that, in response to execution of the instructions by one or more processors, cause the one or more processors to perform the following operations:
determining, based on a participant-contributed message of a first message exchange thread between at least first and second participants, one or more attributes of the first participant;
storing the one or more attributes in association with the first participant;
forming a search query based at least in part on content of the first message exchange thread or content of a second message exchange thread involving the second participant, wherein the search query further includes one or more items selected based on the stored one or more attributes of the first participant;
obtaining content responsive to the search query; and
providing data associated with the responsive content to the second participant.
